(19) United States
(12) Patent Application Publication
(10) Pub. No.: US 2004/0045985 A1
(43) Pub. Date: Mar. 11, 2004

(54) Hand-operated spray pump

(76) Inventor: Chung Kee Lee, Seoul (KR)

Correspondence Address: Mavis S Gallenson, Ladas & Parry, Suite 2100, 5670 Wilshire Boulevard, Los Angeles, CA, 90036-5679, US

(21) Appl. No.: 10/333,179

(22) PCT Filed: May 30, 2001
(86) PCT No.: PCT/KR01/00909

(51) Int. Cl. G01F 11/06

(52) U.S. Cl. 222/321.7

(57) ABSTRACT

The present invention relates to a hand-operated spray pump, and more particularly the hand-operated spray pump with the modified configuration of a hollow rode, a piston and the like, which constitute a hand-operated spray pump, whereby the spray pump has a precompression function and a further lower defect rate in manufacturing.

### FIELD OF THE INVENTION

The present invention relates to a hand-operated spray pump, and more particularly the hand-operated spray pump being formed by modifying the structure of a hollow rode, a piston and the like, which constitute a hand-operated spray pump, whereby the spray pump has a precompression function and a further lower defect rate in manufacturing.

### BACKGROUND OF THE INVENTION

Hand-operated spray pumps have been widely used for their convenience to eject liquids or emulsion contents in a fixed amount in the cosmetic field. Particularly, since the hand-operated spray pumps have charactistics of storing the contents in a vessel and easily spraying them in a fixed amount, they have been widely used and the relevant technologies have steadily been developed.

The hand-opera spray pump generally comprises a housing forming the exterior of pump; a closure serving as fixing the housing to a pump vessel; a hollow rod providing an inner passage from an upper button including a spray nozzle to the interior space of the housing; a piston engaged with the hollow rod, the piston moving upward and downward along the inner wall of the housing; a spring being placed on the inner bottom of the housing; and a ball serving as opening and shutting an lower entrance of the housing.

The technology associated with the hand-operated spray pump has been developed in connection with various modifications of constitutional elements, i.e., modifications of the configuration and function thereof. For example, the procedure that the liquid content compressed in the housing flows into the interior of the hollow rod, was carried out by the configuration of the rod itself in the early stage of development, however, in order to solve the problem thereof in a mass product, a stem was used as a separate element, the stem forming a plurality of small inflow slits when it is joined to the bottom of the cylindrical hollow rod.

In addition to the technical development for solving the problem in a molding field as above, the configuration for solving so called “dropping phenomenon” was also been developed, in which the dropping phenomenon means the phenomenon that, on spraying the liquid content by pushing the button down, a part of the liquid content falls off the nozzle in not a spray form but a drop form Such developed pump is configured to precompress the liquid content in the housing, prior to inflow of the liquid content into the interior of the hollow rod. For instance, the space of a certain length exists on the adjoining portion of the piston and the rod so that, when the button is pushed down for ejection of the liquid content, the liquid content does not flow into the hollow rod in an initial descent step and instead is compressed in the housing. In another configuration, a separate slim ring is installed for precompression.

As illustrated as above, a plurality of spray pump operated in the precompression manner have been known in the prior art and one representative example of them is U.S. Pat. No. 6,209,759. In FIG. 6, illustrated is the device disclosed in this patent, wherein a piston 750 comprises a cylindrical sleeve 760 and an outer seal lip 770 connected thereto, and the outer upper portion of a hollow rod 550 on which an inner top 762 of cylindrical sleeve 760 of the piston 750 adjoins is inclined outward. The portion of the piston 750, on which a vertical extending part 860 of the stem 850 adjoins, is an outer bottom 764 of cylindrical sleeve 760. In a resting mode, as the outer bottom 764 of cylindrical sleeve 760 of the piston 750 comes into contact with the vertical extending part 860 of stem 850, a sealing takes place so that an inner passage is shut between a housing interior space (A) and the hollow rod 550. In a compression mode, the hollow rod 550 descends in the state that the sealing between the outer bottom 764 of piston 750 and the vertical extending part 860 of stem 850 is maintained, so that the inner top 762 of cylindrical sleeve 760 ascends along the inclined plane 552 of hollow rod 550. Accordingly, the housing interior space (A) is further compressed, and when the pressure reaches the fair extent, the liquid content flows into the interior passage of hollow rod 550 by opening the above sealed portion. As a result, the sealed portion and the inclined plane are key elements in the above U.S. patent. However, it is not easy to manufacture the piston 550 of such configuration in a massive product.

Plastic parts are generally manufactured in the injection molding method of using a mold, in which the mold consisting of two mold units is generally used, and a melted plastic material is provided with the interior space that the mold units form Referring to FIGS. 7A to 7C which illustrate the injection molding procedure using the piston mold 2000, the problem associated with the above U.S. patent can be easily understood For manufacture of the piston 750, a space 2750 is formed by interlock of a lower mold 2100 and an upper mold 2120 wherein a part of outer and inner shapes of the piston 750 are carved in the lower mold 2100 and the remaining outer and inner shapes are carved in the upper mold 2120, and then a melt which has been in a runner 2130 flows into the space 2750 through a gate 2140. Herein, the melt is filled in the cylindrical space starting from the bottom thereof and then is divided at the intersecting portion of a cylindrical sleeve 2760 and an outer seal lip 2770. By the way, the air which has been in the space corresponding to the outer seal lip 2770 can exhaust through a parting line 2150 of the upper and lower molds 2100, 2120, whereas the air which has been in the upper space corresponding to the cylindrical sleeve 2760 cannot exhaust Accordingly, it is difficult to manufacture a bottom 2762 of the cylindrical sleeve 2760 in a perfect form, the bottom 2762 being the portion where a sealing takes place for precompression as mentioned above, so that the defect rate in manufacturing is very high. As a result, the perfect precompression cannot be achieved in the above U.S. patent so that the dropping phenomenon occurs.

In a spray pump which is operated by the combination of very fine parts, most of the parts being made of polyethylene or polypropylene in an error range according to the fine molding, the defect rate of manufacture is very important actor. In order to remove the air of the portion 2762, and the configuration of molding apparatus requires the air-removing passage; however, such apparatus is a high price due to the characteristic of fine configuration so that a diversity of developments to solve this problem have been tried for a long time. Moreover, it is also difficult to ascertain whether a fine part manufactured has a defect, thereby raising a production cost.

Therefore, the structure of spray pump capable of solving said problems is strongly required.

### SUMMARY OF INVENTION

An object of the present invention is to provide a finger-operated spray pump of simple configuration that the precompression can be achieved and the dropping phenomenon does not occur.

Another object of the present invention is to provide a finger-operated spray pump of which the defect rate in a mass product is very low and the ascertainment of defect can be easily carried out.

A hand-operated spray pump of the present invention to accomplish these objects comprises,

a housing forming the exterior of pump;

a closure joining the housing to a vessel containing a liquid content, the closure being engaged to the outer surface of the housing;

a hollow rod providing an interconnecting passage between a button having a spray nozzle and the interior space of housing;

a housing cap fixing the hollow rod in the housing and sealing the interior of housing from the exterior, the housing cap being inserted between the housing and the hollow rod;

a piston moving upward and downward along the inner wall of housing, the piston being installed to the lower portion of hollow rod;

a stem forming a plural of inflow slits in combination with the hollow rod, the stem being combined to the bottom of hollow rod;

a spring supporting the stem, the spring being positioned in the lower interior space of housing; and

a ball opening and closing a lower entrance of the housing;

wherein the piston comprises an inner part in contact with the bottom of hollow rod and an outer part in contact with the inner wail of housing, the outer part extending downward from the bottom of inner part and being spread to be pressed a little about the inner wall of housing,

the stem comprises an axial part being inserted to an inflow passage of the bottom of hollow rod, a horizontal part extending horizontally from the bottom of axial part, and a vertical part extending upward and downward from the horizontal part,

whereby, in a resting or compression mode, the inner surface of the outer part of piston comes into contact with the outer top of the axial part of stem to make a sealing, whereas in an ejection mode, the outer part of piston is further spread and thereby the sealing portion with the axial part is separated to remove the sealing.

The term “resting mode” in the present specification means the state that the pump is not in a non-operation, the term “compression mode” means the state that the pump is just prior to ejection of the liquid content by pushing the button down, and the term “ejection mode” means the state that the liquid contents is ejected after the compression mode.

One of the features of the present invention is that the piston moves in integration with the hollow rod and, in the resting mode, the liquid content which is contained in the interior space of housing by the ball placed on the lower entrance of housing is sealed by combination of the outer part of piston and the vertical part of stem and, in the compression mode, the piston integrated with the hollow rod moves downward with maintaining the close contact with the stem so that the liquid content is compressed (recompressed) and, in the ejection mode, as the pressure reaches the fair extent, the outer part of piston is further spread so that the compressed liquid content flows into the inflow passage of hollow rod through the inflow slits which are formed between the hollow rod and the stem.

Accordingly, the liquid content compressed in the interior space of housing removes a sealing by further spreading the cylindrical outer part of piston to accomplish the spraying procedure ultimately, whereby the instantaneous ejection can take place. Furthermore, since the liquid content is compressed as the vertical par of stem moves a little upward along the inclined inner surface of the outer part of piston, the effect of precompression is very high, and a small molding error in the stem and piston does not cause any problem on operation, whereby the dropping phenomenon does not occur.

In another embodiment, in order to reinforce the joint of the housing and the closure, the upper portion of housing includes a top protruding part to be hung on the inner top of closure and a middle projection to support the inner bottom of closure. Moreover, the housing cap which works as fixing the hollow rod to the housing consists of an inner wall and an outer wall, in which a small projection is formed on the middle of the outer wall to reinforce the engagement with the housing. Therefore, the spray pump of the present invention can be easily manufactured and also assembled by a simple configuration thereof.

Materials of the constitutional elements in the present invention are not particularly restricted but, in consideration of the easiness of molding and the price, polypropylene resin is desirable to most of constitutional elements and polyethylene resin is desirable to the piston needing a rather resilient property, wherein the polyethylene resin includes the high density polyethylene (HDPE), the low density polyethylene (LDPE), the linear low density polyethylene (LLPDE), etc. and the LLDPE is particularly preferable. The ball and spring are preferably made of stainless steel.

As shown below, the description refers to the drawing in order to describe the present invention more in detail, thereby, the scope of the invention is however not to be interpreted as a limitation of the invention.

### DETAILED DESCRIPTION OF PREFERRED EMBODIMENTS

FIG. 1A shows a hand-operated spray pump according to an embodiment of the present invention being in the resting mode that a button is not pushed down. The hand-operated spray pump 100 comprises a closure 300 joining a housing 200 of the multistair type to a vessel (not shown), a button 400 including a nozzle 410, a hollow rod 500 connecting the interior space of housing 200 to the button 400 by an interconnecting passage, a housing cap 600 guiding the upward-downward movement of hollow rod 500 and Ding it to the housing 200, a piston 700 moving upward and downward along the inner wall of housing 200 wherein the piston 700 is installed on the lower portion of hollow rod 500, a stem 800 being engaged to the bottom of hollow rod 500, a spring 900 being positioned between the stem 800 and the lower portion of housing 200, and a ball 1000 being placed on a lower entrance of housing 200.

FIG. 2 shows the detailed configuration of piston 700 and its neighbor elements being in the resting mode. The piston 700 comprises an inner part 710 being in contact with the lower portion 510 of hollow rod 500 and an outer part 720 being in contact with the inner wall of housing 200, in which the outer part 720 is rather compressed. The outer part 720 is configured to extend laterally from the bottom of inner part 710 and then further downward than the inner part 710. In particular, the outer part 720 is spread outward so that the lower diameter thereof is larger than the upper diameter. Accordingly, the outer portion 772 of the outer part 720 comes into contact with the inner wall of housing 200 in the rather compressed state. The piston 700 is engaged to the lower portion 510 of hollow rod 500 so that, in order to secure the engagement, a projection 712 is formed on an inner surface 710 of piston 700.

Meanwhile, the stem 800 comprises an axial part 810 being inserted into the bottom of hollow rod 500, a horizontal part 820 extending horizontally from the bottom of axial part 810, and a vertical part 830 extending upward and downward from the horizontal part 820. In the state that the stem 800 joins to the hollow rod 500, a plurality of inflow slits 812, 814, through which the liquid content flows into the inflow passage 520 of hollow rod 500, are formed on such joint portion.

In the resting mode or compression mode, the outer top 832 of the vertical part 830 of stem 800 comes into contact with the inner surface 724 of the outer part 720 of piston 700 so that the interior space (A) of housing 200 is closed.

FIG. 1B shows the state that the liquid content is ejected by pushing the pump of FIG. As a button 400 is pushed down, the hollow rod 500 moves downward, whereby the piston 700 and stem 800 which are integrated with the hollow rod 500 also move down The liquid content being in the housing interior space (A) is compressed by downward-movement of the piston 700, but the sealing between the piston 700 and the stem 800 is continuously maintained. When the pressure reaches the fair extent, the outer part 720 of piston 700 is spread so as to reduce the excessive pressure, as illustrated in FIG. 3, whereby the sealing between the outer part 720 and the vertical part 830 is removed and thus the liquid content being in the housing interior space (A) flows through the inflow slits 812, 814.

Referring to FIG. 5, in a mold 2000 for molding the piston of the present invention, a melt (melted plastic resin) being in a runner 2130 flows through a gate 2140 to fill a space 2710 corresponding to the inner part 710 of piston 700 and, after a consecutive ascent, fill a space 2720 corresponding to the outer part 720. Herein, the air which has remained in the interior space of mold 2000 can exhaust from the space 2720 through the parting line 2150 of mold 2000. Accordingly, the problem mentioned in the above U.S. patent does not take place. Moreover, even when the bottom of outer part 720 is not manufactured in a perfect form, the problem associated with the operation of pump does not take place.

FIG. 4 shows the joint configuration of the housing 200, closure 300, hollow rod 400 and housing cap 600 in detail.

The upper portion of housing 200 includes atop protruding part 210, which is hung on the top 312 of closure joint part 310, and a small projection 220 which is engaged to the bottom 314 of closure joint part 310, so that joint of the housing 200 and closure 300 is further reinforced. By such configuration for joint, an excessive force needs not be applied to the closure 300 for maintenance of the joint and thereby the closure 300 is not destroyed by stress in its fabrication and operation procedure. Meanwhile, a small projection 610 is formed on the inner surface of housing cap 600 so as to reinforce joint between the housing cap 600 and housing 200, and the inner wall of housing 200 is recessed so as to fix the position that the housing cap 600 is inserted, as illustrated above.

The present invention being thus descried, it will be obvious that the same may be varied in many ways. Such variations are not to be regarded as a departure from the spirit and scope of the invention and all such modifications would be obvious to one skilled in the art.

### BRIEF DESCRIPTION OF THE DRAWINGS

FIG. 1A is a vertical cross-sectional view of a hand-operated spray pump being in the resting mode, according to an embodiment of the present invention.

FIG. 1B is a vertical cross-sectional view of the hand-operated spray pump being in the ejection mode.

FIG. 2 is a partial magnified view of a piston and its surrounding elements of FIG. 1A.

FIG. 3 is a partial magnified view of a piston and its surrounding elements of FIG. 1B.

FIG. 4 is a partial magnified view of showing the joint configuration of a closure, housing, and housing cap of FIG. 1A.

FIG. 5 is a partial cross-sectional view of a mold for manufacturing a piston according to an embodiment of the present invention.

FIG. 6 is a partial magnified view of a piston and its surrounding elements in the prior art.

FIGS. 7A to 7C are vertical and horizontal cross-sectional views of a mold for manufacturing the piston of FIG. 6.

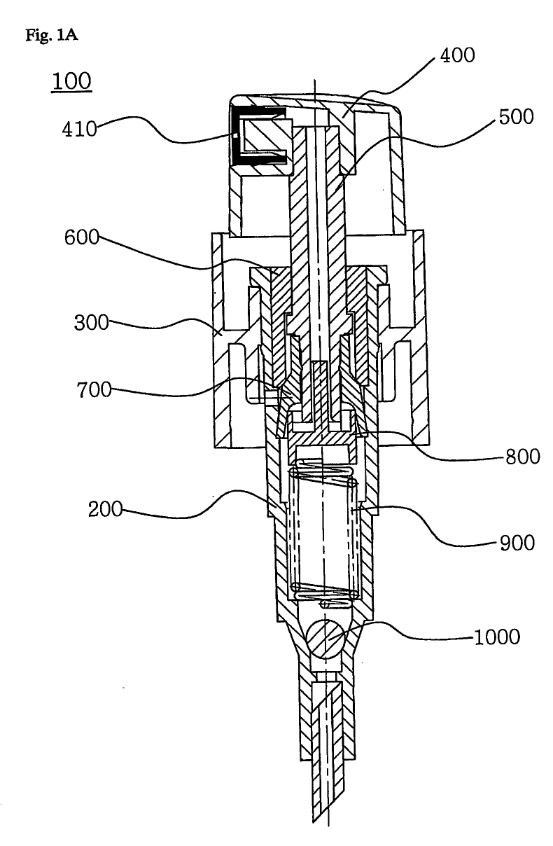

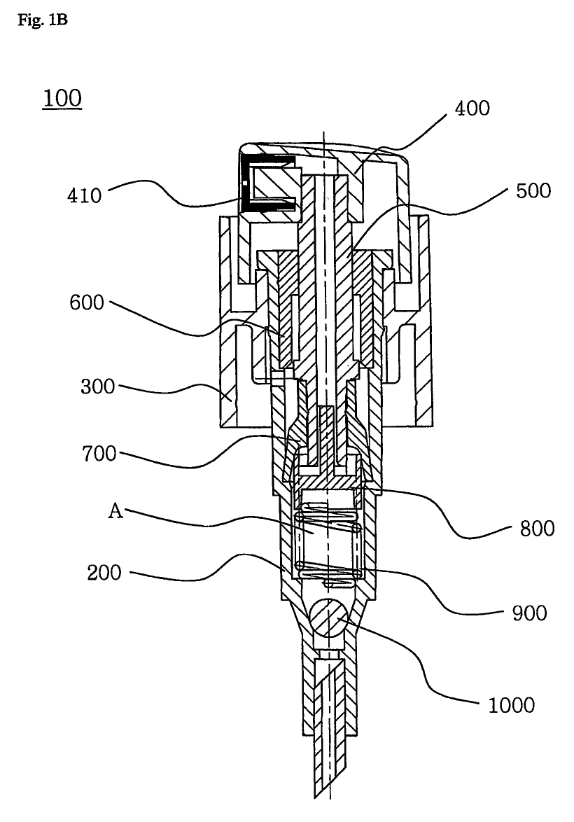

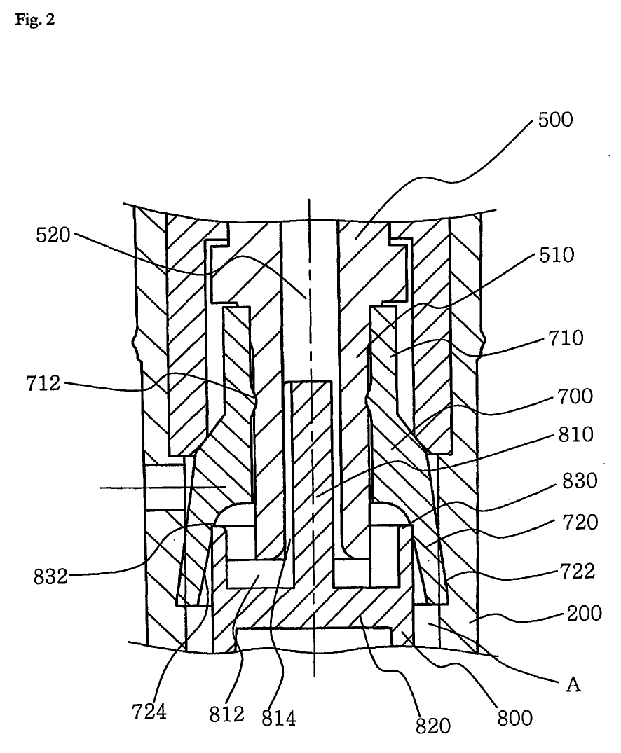

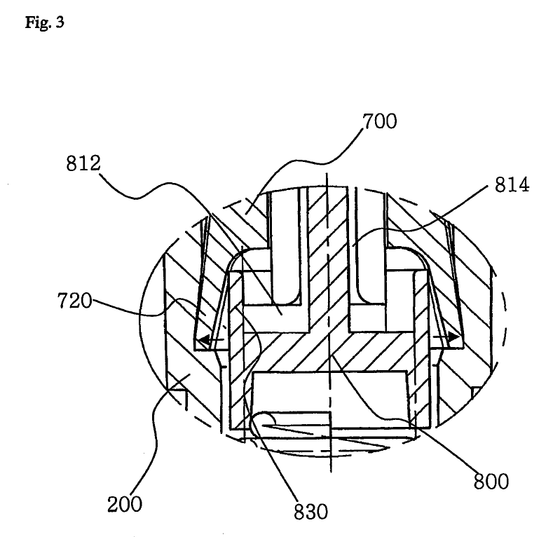

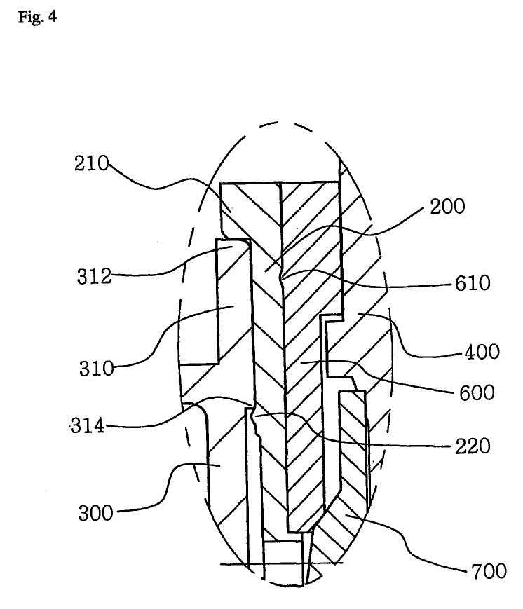

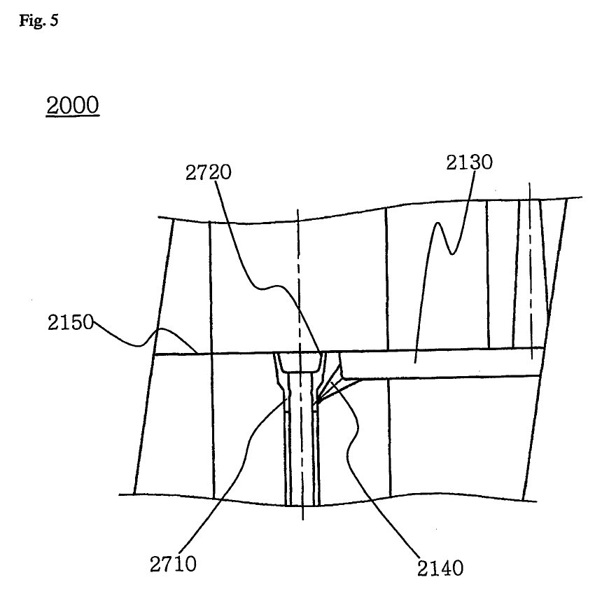

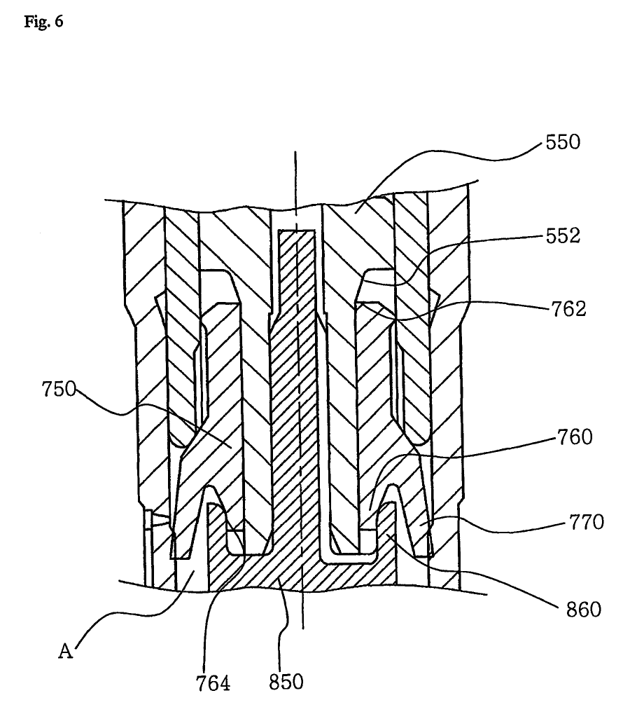

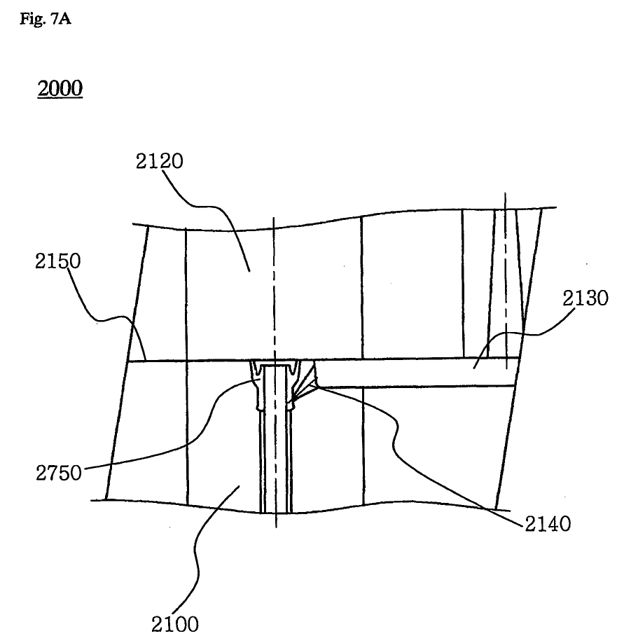

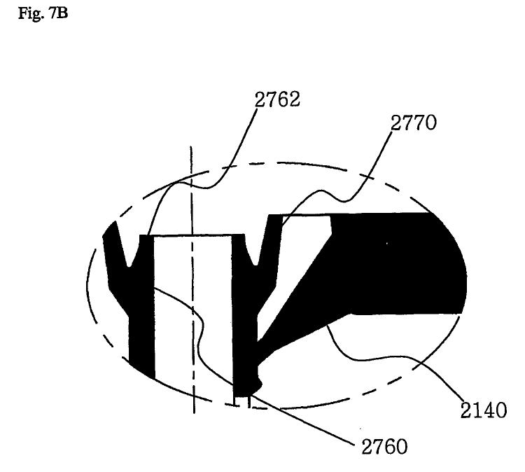

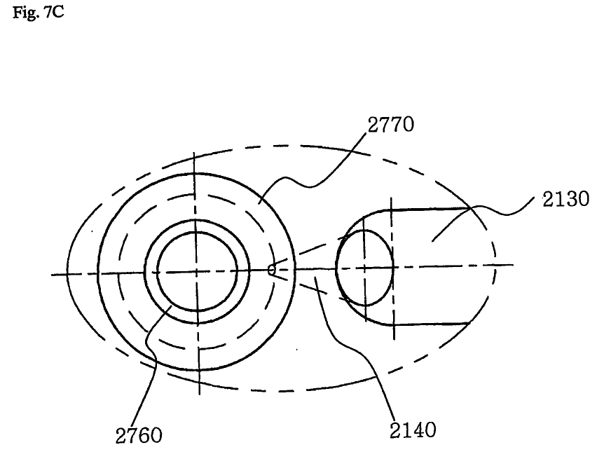

### DESIGNATION OF THE REFERENCE NUMBERS

100: hand-operated spray pump

200: housing

300: closure

400: button

500: hollow rod

600: housing cap

700: piston

800: stem

900: spring

1000: ball

2000: piston mold

### INDUSTRIAL APPLICABILITY

As described above, the hand-operated spray pump of the present invention has the precompression function despite a simple configuration and can be easily manufactured and assembled, whereby the defect rate in a massive product is very low. Furthermore, the hand-operated spray pump can be operated without any problem even when its constitutional elements are manufactured with a small molding error and it is easy to ascertain if the manufactured elements have a defect, so that the spray pump having a high performance can be manufactured in a low price.

What is claimed is:

1. A hand-operated spray pump comprising,
a housing forming the exterior of pump;
a closure joining the housing to a vessel containing a liquid content, the closure being engaged to the outer surface of the housing;
a hollow rod providing an interconnecting passage between a button having a spray nozzle and the interior space of housing;
a housing cap fixing the hollow rod in the housing and sealing the interior of housing from the exterior, the housing cap being inserted between the housing and the hollow rod;
a piston moving upward and downward along the inner wall of housing, the piston being installed to the lower portion of hollow rod;
a stem forming a plurality of inflow slits in combination with the hollow rod, the stem being combined to the bottom of hollow rod;
a spring supporting the stem, the spring being positioned in the lower interior space of housing; and
a ball opening and closing a lower entrance of the housing;
wherein the piston comprises an inner part in contact with the bottom of hollow rod and an outer part in contact with the inner wall of housing, the outer part extending downward from the bottom of inner part and being spread to be pressed a little about the inner wall of housing,
the stem comprises an axial part being inserted to an inflow passage of the bottom of hollow rod, a horizontal part extending horizontally from the bottom of axial part, and a vertical part extending upward and downward from the horizontal part,
whereby, in a resting or compression mode, the inner surface of the outer part of piston comes into contact with the outer top of the axial part of stem to make a sealing, whereas in an ejection mode, the outer part of piston is further spread and thereby the sealing portion with the axial part is separated to remove the sealing.

2. The hand-operated spray pump according to claim 1, wherein the upper portion of housing includes a top protruding part to be hung on the inner top of closure and a middle projection to support the inner bottom of closure so as to in order to reinforce the joint of the housing and the closure

3. The hand-operated spray pump according to claim 1, wherein the housing cap consists of an inner wall and an outer wall, in which a small projection is formed on the middle of the outer wall so as to reinforce the engagement with the housing.

4. The hand-operated spray pump according to one of claims 1 to 3, wherein the piston is made of the linear low density polyethylene resin, the ball and spring are made of the stainless steel, and the remaining elements are made of the polypropylene resin.
